(19) United States
(12) Patent Application Publication
(10) Pub. No.: US 2012/0136604 A1
(43) Pub. Date: May 31, 2012

(54) METHOD AND APPARATUS FOR 3D ATTITUDE ESTIMATION

(75) Inventors: Hsiang-Wen Hsieh, Qionglin Township (TW); Yu-Kuen Tsai, New Taipei City (TW); Chia-Lin Kuo, Dayuan Township (TW); Hung-Hsiu Yu, Changhua City (TW)

(73) Assignee: INDUSTRIAL TECHNOLOGY RESEARCH INSTITUTE, HSINCHU (TW)

(21) Appl. No.: 13/190,636

(22) Filed: Jul. 26, 2011

(30) Foreign Application Priority Data
Nov. 30, 2010 (TW) 99141559

(51) Int. Cl. G06F 19/00; G01C 25/00

(52) U.S. Cl. 702/93

(57) ABSTRACT

A method and an apparatus for estimating 3D attitude are disclosed. The method comprises following steps. A set of current angular velocity, a set of current magnetic flux and a set of acceleration of a carrier are sensed. A set of estimated attitude angles are estimated according to the set of current angular velocities, a set of history attitude angles and a motion model. A disturbance parameter is calculated according the set of current magnetic flux and a set of history magnetic flux. It is determined whether the disturbance parameter is more than a disturbance threshold or not. If yes, the set of estimated attitude angles are updated according to the set of current accelerations not the set of current magnetic flux. If not, the set of estimated attitude angles are updated according to the set of current accelerations and the set of current magnetic flux.

### RELATED APPLICATION

This application claims the benefit of Taiwan patent application Serial No. 99141559, filed Nov. 30, 2010, the subject matter of which is incorporated herein by reference.

### TECHNICAL FIELD

The disclosure relates in general to a method for attitude estimation, and more particularly to a method and an apparatus for three-dimensional (3D) attitude estimation.

### BACKGROUND

FIG. 1 is a schematic diagram of a first related art. The first related art is relative to a China patent publication No. CN1664506A. In the first related art, a sensor includes a first accelerometer 11, a second accelerometer 12, a third accelerometer 13, a first magnetometer 21, a second magnetometer 22, a third magnetometer 23, a first rate gyroscope 31, a second rate gyroscope 32, and a third rate gyroscope 33. The object is to obtain signals from the first rate gyroscope 31, the second rate gyroscope 32, and the third rate gyroscope 33, and perform calculations on the first accelerometer 11, the second accelerometer 12, the third accelerometer 13, the first magnetometer 21, the second magnetometer 22, and the third magnetometer 23. Then, in an attempt to remove or filter out false signals detected by the accelerometers and magnetometers, the filtered result is converted into the attitude angle of a carrier.

FIG. 2 is a schematic diagram of a second related art. The second related art is relative to a China patent publication No. CN1740746A. In the second related art, a micro-dynamic carrier attitude measuring apparatus 3 includes a three-axial rate gyroscope 101, a three-axial magnetic field meter 102, a uniaxial accelerometer 103, a temperature sensor 104, a uniaxial rate sensor 105, a model conversion circuit 106, a microprocessor and storage 107, and a serial communication port 108. The second related art uses the three-axial magnetic field meter 102, the three-axial rate gyroscope 101, and the uniaxial accelerometer 102 to update a direction cosine matrix, and estimate the attitude of the carrier according to the updated direction cosine matrix.

### SUMMARY

Embodiments are disclosed for a method and an apparatus for estimating three-dimensional attitude, in which an improved resistance to magnetic disturbance can be achieved.

According to an aspect of the present disclosure, a method is provided for estimating three-dimensional attitude. The method includes: detecting a set of current angular velocity, a set of current magnetic flux, and a set of current acceleration of a carrier; estimating a set of attitude angle according to the set of current angular velocity, a set of history attitude angle, and a motion model; calculating a disturbance parameter according the set of current magnetic flux and a set of history magnetic flux; determining whether the disturbance parameter exceeds a disturbance threshold; updating, when the disturbance parameter is determined exceeding the disturbance threshold, the set of estimated attitude angle according to the set of current acceleration not the set of current magnetic flux; and updating, when the disturbance parameter is determined not exceeding the disturbance threshold, the set of estimated attitude angle according to both the set of current acceleration and the set of current magnetic flux.

According to another aspect of the present disclosure, an apparatus is provided for estimating three-dimensional attitude. The apparatus includes a first inertial sensing element, a second inertial sensing element, a magnetic sensing element, and a processor. The first inertial sensing element detects a set of current angular velocity of a carrier. The second inertial sensing element detects a set of current acceleration of the carrier. The magnetic sensing element detects a set of current magnetic flux of the carrier. The processor estimates a set of attitude angle according to the set of current angular velocity, a set of history attitude angle, and a motion model. The processor calculates a disturbance parameter according the set of current magnetic flux and a set of history magnetic flux. The processor determines whether the disturbance parameter exceeds a disturbance threshold. When the disturbance parameter is determined exceeding the disturbance threshold, the processor updates the set of estimated attitude angle according to the set of current acceleration not the set of current magnetic flux. When the disturbance parameter is determined not exceeding the disturbance threshold, the processor updates the set of estimated attitude angle according to both the set of current acceleration and the set of current magnetic flux.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a first related art.

FIG. 2 is a schematic diagram of a second related art.

FIG. 3 is a block diagram showing an apparatus for estimating three-dimensional attitude according to the disclosure.

FIG. 4 is a flow chart showing a method for estimating three-dimensional attitude according to the disclosure.

FIG. 5 is a flow chart showing details of step 42.

FIG. 6 is a flow chart showing details of step 45.

FIG. 7 is a flow chart showing details of step 46.

FIG. 8 is a schematic diagram showing the relationship between a carrier's local coordinate system and the world coordinate system.

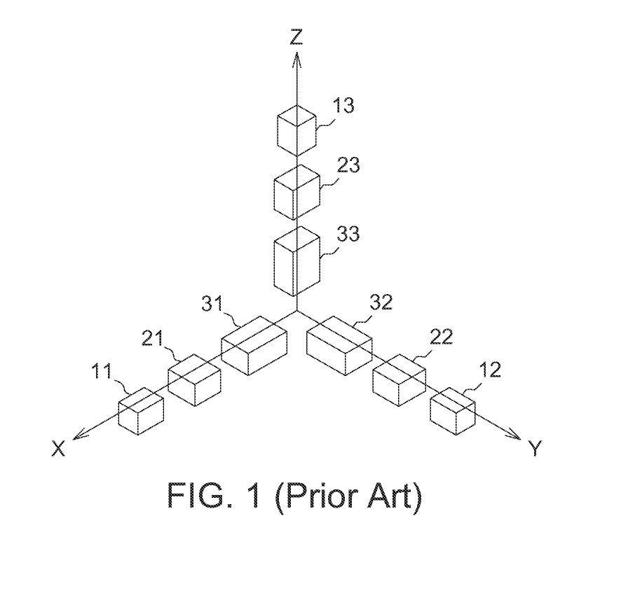

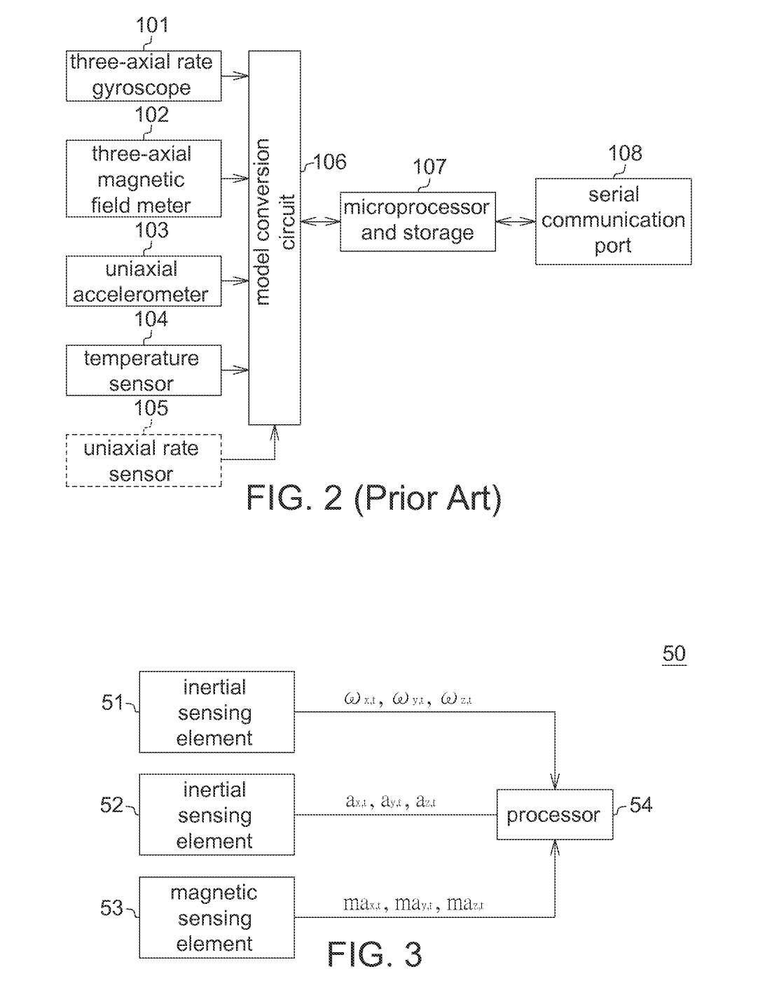

### DETAILED DESCRIPTION OF THE DISCLOSURE

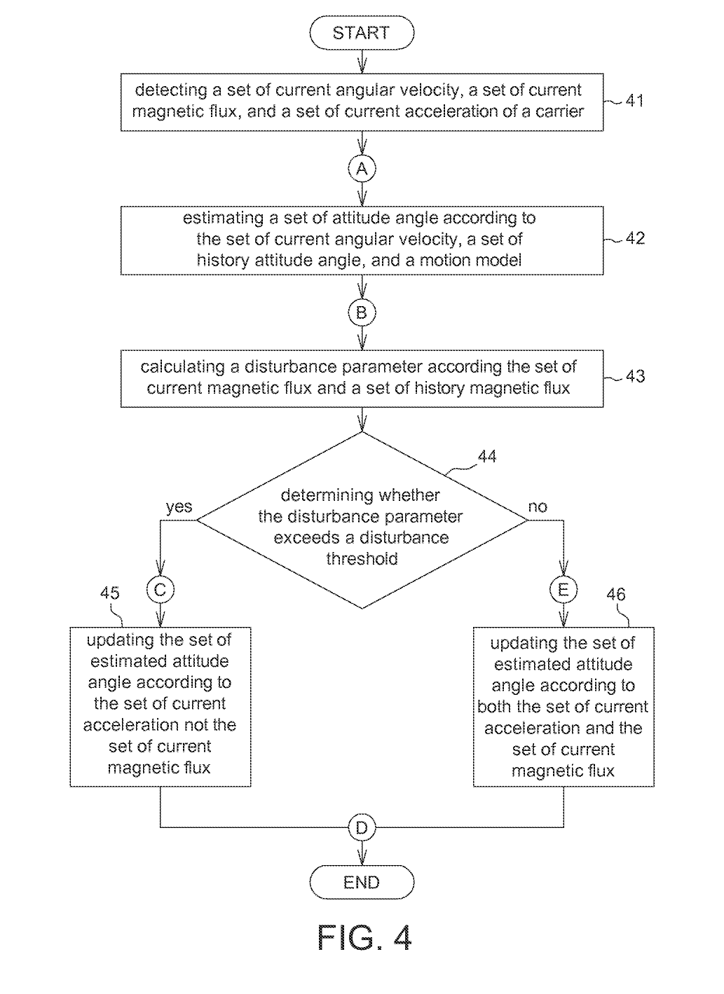

FIG. 3 is a block diagram showing an apparatus for estimating three-dimensional attitude according to the disclosure. FIG. 4 is a flow chart showing a method for estimating three-dimensional attitude according to the disclosure. Refer to both FIGS. 3 and 4. The three-dimensional attitude estimation apparatus 50 includes an inertial sensing element 51 for measuring 3D angular velocities, an inertial sensing element 52 for measuring 3D accelerations, a magnetic sensing element 53 for measuring 3D magnetic flux, and a processor 54. The inertial sensing element 51 and the inertial sensing element 52 are for example a gyroscope and an accelerometer, respectively. The magnetic sensing element 53 is for example a digital compass, a magnetic resistance/impedance meter, a magneto-inductive wire device, or a Hall effect sensor.

The method for estimating three-dimensional attitude can be applied in the estimation apparatus 50, which at least includes a number steps as follows. In step 41, the inertial sensing element 51 detects a set of current angular velocity of a carrier. The set of current angular velocity includes a current angular velocity ω_{x,t}, a current angular velocity ω_{x,t}, and a current angular velocity ω_{z,t}. The current angular velocity ω_{x,t}, the current angular velocity ω_{y,t}, and the current angular velocity ω_{z,t}, are indicative of a three-axial angular velocity of the carrier at time t. The inertial sensing element 52 detects a set of current acceleration of the carrier. The set of current acceleration includes a current acceleration a_{x,t}, a current acceleration a_{y,t}, and a current acceleration a_{z,t}. The current acceleration a_{x,t}, the current acceleration a_{y,t}, and the current acceleration a_{z,t}, are indicative of a three-axial acceleration of the carrier at time t. The magnetic sensing element 53 detects a set of current magnetic flux of the carrier. The set of current magnetic flux includes a current magnetic flux ma_{x,t}, a current magnetic flux ma_{y,t}, and a current magnetic flux ma_{z,t}. The current magnetic flux ma_{x,t}, the current magnetic flux ma_{y,t}, and the current magnetic flux ma_{z,t} are indicative of a three-axial magnetic flux of the carrier at time t.

In step 42, the processor 54 estimates a set of attitude angle according to the set of current angular velocity, a set of history attitude angle, and a motion model. The set of history attitude angle includes a history attitude angle φₜ₋₁, a history attitude angle θₜ₋₁, and a history attitude angle ψₜ₋₁. The set of estimated attitude angle includes an estimated attitude angle φₜ, an estimated attitude angle θₜ, and an estimated attitude angle ψₜ. The history attitude angle φₜ₋₁, the history attitude angle θₜ₋₁, and the history attitude angle ψₜ₋₁ are indicative of estimated attitude angles of the carrier at time t−1. The estimated attitude angle φₜ, the estimated attitude angle θₜ, and the estimated attitude angle ψₜ are indicative of estimated attitude angles of the carrier at time t.

In step 43, the processor calculates a disturbance parameter according the set of current magnetic flux and a set of history magnetic flux. The set of history magnetic flux includes a history magnetic flux ma_{x,t-1}, a history magnetic flux ma_{y,t-1}, and a history magnetic flux ma_{z,t-1}. The history magnetic flux ma_{x,t-1}, the history magnetic flux ma_{y,t-1}, and the history magnetic flux ma_{z,t-1} are indicative of a three-axial magnetic flux of the carrier at time t−1. The disturbance parameter is for example the absolute value of a change in magnetic flux, the absolute value of a change in magnetic inclination angle, or a combination change. The absolute value of the change in magnetic flux can be described in terms of |Δm|=|∥mₜ∥−∥mₜ₋₁∥|, where the norm of the set of current magnetic flux can be described in terms of ∥mₜ∥=\sqrt{ma_{x,t}²+ma_{y,t}²+ma_{z,t}²}, and the norm of the set of history magnetic flux can be described in terms of ∥mₜ₋₁∥=\sqrt{ma_{x,t-1}²+ma_{y,t-1}²+ma_{z,t-1}²}. As regards mₜ, an initial value m₀ can be configured as a magnetic inclination angle λ in view of Earth's magnetic field.

The absolute value of a change in magnetic inclination angle can be described in terms of |Δφ|=|φ_{mag,t}−φ_{mag,t-1}|, where a current magnetic inclination angle can be described in terms of

$${ϕ}_{mag , t} = arctan ( \frac{{m}_{Gz , t}}{\sqrt{{m}_{Gx , t}^{2} + {m}_{Gy , t}^{2}}} ) ,$$

and a history magnetic inclination angle can be described in terms of

$${ϕ}_{mag , t - 1} = arctan ( \frac{{m}_{Gz , t - 1}}{\sqrt{{m}_{Gx , t - 1}^{2} + {m}_{Gy , t - 1}^{2}}} ) .$$

In this case, a current magnetic flux m_{Gx,t}, a current magnetic flux m_{Gy,t}, and a current magnetic flux m_{Gz,t}, which are indicative of a three-axial magnetic flux in the world coordinate, can be converted from the local coordinate of the carrier described in terms of the current magnetic flux ma_{x,t}, the current magnetic flux ma_{y,t}, and the current magnetic flux ma_{z,t}. Plus, a history magnetic flux M_{Gx,t-1}, a history magnetic flux m_{Gy,t-1}, and history magnetic flux m_{Gz,t-1}, which are indicative of a three-axial magnetic flux in the world coordinate, can be converted from the local coordinate of the carrier described in terms of the history magnetic flux ma_{x,t-1}, the history magnetic flux ma_{y,t-1}, and the history magnetic flux ma_{z,t-1}. The combination change can be described in terms of D=Dₘ|∥mₜ∥−∥mₜ₋₁∥|+D_{φ}|φ_{mag,t}−φ_{mag,t-1}|, where there are a weighting value Dₘ for the change in magnetic flux and a weighting value D_{φ} for the change in magnetic inclination angle that can be used to adjust or modify the significance of the combination change.

In step 44, the processor 54 determines whether the disturbance parameter exceeds a disturbance threshold. When the disturbance parameter is determined exceeding the disturbance threshold, step 45 is executed. On the other hand, when the disturbance parameter is determined not exceeding the disturbance threshold, step 46 is executed. As an example where the disturbance threshold is the aforementioned combination change D, the processor 54 determines whether the combination change D exceeds a disturbance threshold Dthr or not. If the combination change D is determined exceeding the disturbance threshold Dthr, step 45 is executed. On the other hand, if the combination change D is determined not exceeding the disturbance threshold Dthr, step 46 is executed.

In step 45, where the disturbance parameter is determined exceeding the disturbance threshold, the processor 54 updates the set of estimated attitude angle according to the set of current acceleration not the set of current magnetic flux. More specifically, where the disturbance parameter is determined exceeding the disturbance threshold, the processor 54 does not depend on the current magnetic flux ma_{x,t}, the current magnetic flux ma_{y,t}, and the current magnetic flux ma_{z,t}, to update the estimated attitude angle φₜ, the estimated attitude angle θₜ, and the estimated attitude angle ψₜ. Instead, the processor 54 depends on the current acceleration a_{x,t}, the current acceleration a_{y,t}, and the current acceleration a_{z,t}, to update the estimated attitude angle φₜ, the estimated attitude angle θₜ, and the estimated attitude angle ψₜ. From a larger disturbance parameter than the disturbance threshold, it can be determined that the three-dimensional attitude estimation apparatus 50 is affected by magnetic disturbance. In this case, a false or erroneous estimated result of the three-dimensional attitude will be generated if the estimated attitude angle φₜ, the estimated attitude angle θₜ, and the estimated attitude angle ψₜ are updated according to the current magnetic flux ma_{x,t}, the current magnetic flux ma_{y,t}, and the current magnetic flux ma_{z,t}. In view of this, where there is a larger disturbance parameter than the disturbance threshold, the current magnetic flux ma_{x,t}, the current magnetic flux ma_{y,t}, and the current magnetic flux ma_{z,t} are neglected or ignored in updating the estimated attitude angle φₜ, the estimated attitude angle θₜ, and the estimated attitude angle ψ. Therefore, the resistance to magnetic disturbance can be an improved, and the accuracy of three-dimensional attitude estimation can be increased.

In step 46, where the disturbance parameter is determined not exceeding the disturbance threshold, the processor 54 updates the set of estimated attitude angle according to both the set of current acceleration and the set of current magnetic flux. More specifically, where the disturbance parameter is determined not exceeding the disturbance threshold, the processor 54 depends on the current magnetic flux ma_{x,t}, the current magnetic flux ma_{y,t}, and the current magnetic flux ma_{z,t} as well as the current acceleration a_{x,t}, the current acceleration a_{y,t}, and the current acceleration a_{z,t}, to update the estimated attitude angle φₜ, the estimated attitude angle θₜ, and the estimated attitude angle ψₜ.

As regards the estimated attitude angle φₜ, the estimated attitude angle θₜ, and the estimated attitude angle ψₜ, they can be updated by using a filter which is for example an algorithm filter that the processor 54 executes. The filter is for example a Bayesian filter, or an extended Kalman filter (EKF).

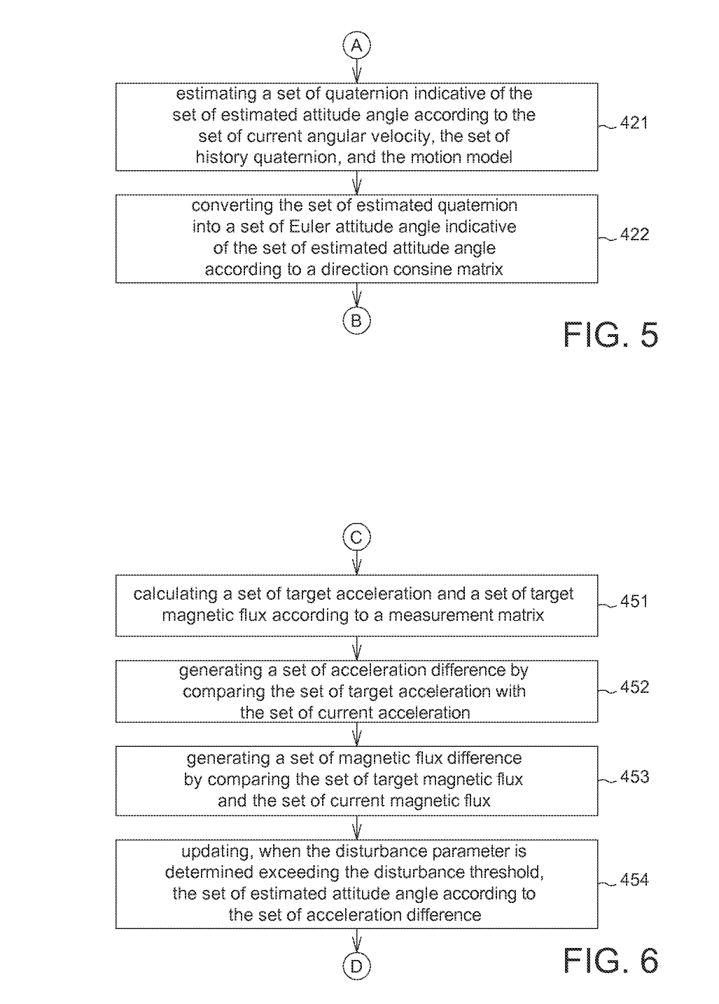

FIG. 5 is a flow chart showing details of step 42. Refer to FIGS. 3, 4, and 5. The processor 54 expresses the set of history attitude angle as a history quaternion according to a direction sine matrix. In other words, the history attitude angle φₜ₋₁, the history attitude angle θₜ₋₁, and the history attitude angle ψₜ₋₁ can be expressed as a history quaternion in terms of

$$[ \begin{matrix}{e}_{0 , t - 1} \\ {e}_{1 , t - 1} \\ {e}_{2 , t - 1} \\ {e}_{3 , t - 1}\end{matrix} ] .$$

The aforementioned step 42 further includes step 421 and step 422. In step 421, the processor 54 estimates a set of quaternion

$$[ \begin{matrix}{e}_{0 , t} \\ {e}_{1 , t} \\ {e}_{2 , t} \\ {e}_{3 , t}\end{matrix} ]$$

according to the set of current angular velocity, the set of history quaternion

$$[ \begin{matrix}{e}_{0 , t - 1} \\ {e}_{1 , t - 1} \\ {e}_{2 , t - 1} \\ {e}_{3 , t - 1}\end{matrix} ] ,$$

and the motion model. The motion model can be described in terms of

$$[ \begin{matrix}{e}_{0 , t} \\ {e}_{1 , t} \\ {e}_{2 , t} \\ {e}_{3 , t}\end{matrix} ] = [ \begin{matrix}1 & - 0.5 {ω}_{z , t} t & - 0.5 {ω}_{y , t} t & - 0.5 {ω}_{z , t} t \\ 0.5 {ω}_{x , t} t & 1 & 0.5 {ω}_{y , t} t & - 0.5 {ω}_{z , t} t \\ 0.5 {ω}_{y , t} t & - 0.5 {ω}_{z , t} t & 1 & 0.5 {ω}_{x , t} t \\ - 0.5 {ω}_{z , t} t & 0.5 {ω}_{y , t} t & 0.5 {ω}_{x , t} t & 1\end{matrix} ] [ \begin{matrix}{e}_{0 , t - 1} \\ {e}_{1 , t - 1} \\ {e}_{2 , t - 1} \\ {e}_{3 , t - 1}\end{matrix} ] + {ɛ}_{t} ,$$

where εₜ denotes a noise induced by the inertial sensing element 51.

In step 422, the processor 54 converts the set of estimated quaternion

$$[ \begin{matrix}{e}_{0 , t} \\ {e}_{1 , t} \\ {e}_{2 , t} \\ {e}_{3 , t}\end{matrix} ]$$

into a set of Euler attitude angle according to a direction cosine matrix. The set of Euler attitude angle is indicative of the estimated attitude angles, i.e., the estimated attitude angle φₜ, the estimated attitude angle θₜ, and the estimated attitude angle ψₜ.

FIG. 6 is a flow chart showing details of step 45. The aforementioned step 45 further includes steps 451 to 454. In step 451, the processor 54 calculates a set of target acceleration

$${[ \begin{matrix}{am}_{x , t} \\ {am}_{y , t} \\ {am}_{z , t}\end{matrix} ]}_{t}$$

and a set of target magnetic flux

$${[ \begin{matrix}{mp}_{x , t} \\ {mp}_{y , t} \\ {mp}_{z , t}\end{matrix} ]}_{t}$$

according to a measurement matrix. The measurement matrix can be described in terms of zₜ=h(xₜ)+δₜ, where Xₜ denotes the carrier's attitude at time t, i.e., the estimated attitude angles

$$[ \begin{matrix}{e}_{0 , t} \\ {e}_{1 , t} \\ {e}_{2 , t} \\ {e}_{3 , t}\end{matrix} ] ,$$

Zₜ denotes a measurement information received by the carrier at time t and converted from a transfer function h, and δₜ denotes a noise in the estimated and the measured result of carrier's attitude.

The target acceleration can be described in terms of

$${[ \begin{matrix}{am}_{x , t} \\ {am}_{y , t} \\ {am}_{z , t}\end{matrix} ]}_{t} = [ \begin{matrix}2 ( {e}_{1} {e}_{3} - {e}_{0} {e}_{2} ) \\ 2 ( {e}_{2} {e}_{3} + {e}_{0} {e}_{1} ) \\ ( {e}_{0}^{2} - {e}_{1}^{2} - {e}_{2}^{2} + {e}_{3}^{2} )\end{matrix} ] + {δ}_{at} ,$$

where δₐₜ denotes a noise induced by the inertial sensing element 52. The target magnetic flux can be described in terms of

$${[ \begin{matrix}{mp}_{x , t} \\ {mp}_{y , t} \\ {mp}_{z , t}\end{matrix} ]}_{t} = [ \begin{matrix}( {e}_{0}^{2} + {e}_{1}^{2} - {e}_{2}^{2} - {e}_{3}^{2} ) cos λ + 2 ( {e}_{1} {e}_{3} - {e}_{0} {e}_{2} ) sin λ \\ 2 ( {e}_{1} {e}_{2} - {e}_{0} {e}_{3} ) cos λ + 2 ( {e}_{2} {e}_{3} + {e}_{0} {e}_{1} ) sin λ \\ 2 ( {e}_{1} {e}_{3} + {e}_{0} {e}_{2} ) cos λ + ( {e}_{0}^{2} - {e}_{1}^{2} - {e}_{2}^{2} + {e}_{3}^{2} ) sin λ\end{matrix} ] + {δ}_{mt} ,$$

where δₘₜ denotes a noise induced by the magnetic sensing element 53.

In step 452, a set of acceleration difference is generated by comparing the target acceleration

$${[ \begin{matrix}{am}_{x , t} \\ {am}_{y , t} \\ {am}_{z , t}\end{matrix} ]}_{t}$$

with the current acceleration

$${[ \begin{matrix}{a}_{x , t} \\ {a}_{y , t} \\ {a}_{z , t}\end{matrix} ]}_{t} .$$

In step 453, a set of magnetic flux difference is generated by comparing the set of target magnetic flux

$${[ \begin{matrix}{mp}_{x , t} \\ {mp}_{y , t} \\ {mp}_{z , t}\end{matrix} ]}_{t}$$

and the set of current magnetic flux

$${[ \begin{matrix}{ma}_{x , t} \\ {ma}_{y , t} \\ {ma}_{z , t}\end{matrix} ]}_{t}$$

In step 454, when the disturbance parameter is determined exceeding the disturbance threshold, the estimated attitude angle φₜ, the estimated attitude angle θₜ, and the estimated attitude angle ψₜ are updated according to the set of acceleration difference.

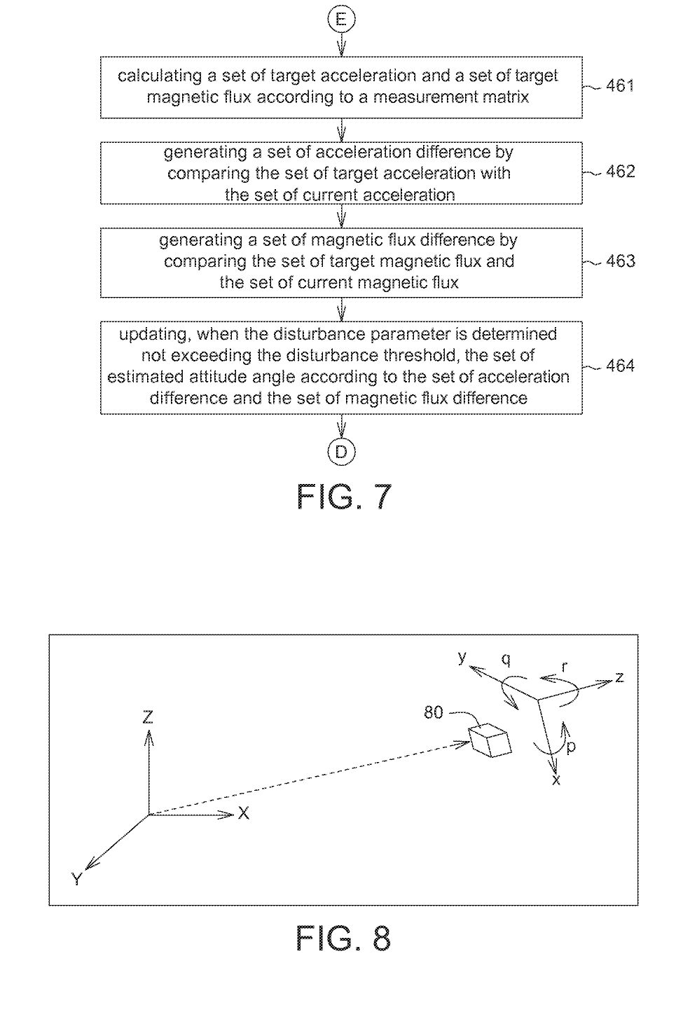

FIG. 7 is a flow chart showing details of step 46. The aforementioned step 46 further includes steps 461 to 464. In step 461, the processor 54 calculates a set of target acceleration

$${[ \begin{matrix}{am}_{x , t} \\ {am}_{y , t} \\ {am}_{z , t}\end{matrix} ]}_{t}$$

and a set of target magnetic flux

$${[ \begin{matrix}{mp}_{x , t} \\ {mp}_{y , t} \\ {mp}_{z , t}\end{matrix} ]}_{t}$$

according to a measurement matrix. The measurement matrix can be described in terms of zₜ=h(xₜ)+δₜ, where Xₜ denotes the carrier's attitude at time t, i.e., the estimated attitude angles

$$[ \begin{matrix}{e}_{0 , t} \\ {e}_{1 , t} \\ {e}_{2 , t} \\ {e}_{3 , t}\end{matrix} ] ,$$

Zₜ denotes a measurement information received by the carrier at time t and converted from a transfer function h, and δₜ denotes a noise in the estimated and the measured result of carrier's attitude.

The target acceleration can be described in terms of

$${[ \begin{matrix}{am}_{x , t} \\ {am}_{y , t} \\ {am}_{z , t}\end{matrix} ]}_{t} = [ \begin{matrix}2 ( {e}_{1} {e}_{3} - {e}_{0} {e}_{2} ) \\ 2 ( {e}_{2} {e}_{3} + {e}_{0} {e}_{1} ) \\ ( {e}_{0}^{2} - {e}_{1}^{2} - {e}_{2}^{2} + {e}_{3}^{2} )\end{matrix} ] + {δ}_{at} ,$$

where δₐₜ denotes a noise induced by the inertial sensing element 52. The target magnetic flux can be described in terms of

$${[ \begin{matrix}{mp}_{x , t} \\ {mp}_{y , t} \\ {mp}_{z , t}\end{matrix} ]}_{t} = [ \begin{matrix}( {e}_{0}^{2} + {e}_{1}^{2} - {e}_{2}^{2} - {e}_{3}^{2} ) cos λ + 2 ( {e}_{1} {e}_{3} - {e}_{0} {e}_{2} ) sin λ \\ 2 ( {e}_{1} {e}_{2} - {e}_{0} {e}_{3} ) cos λ + 2 ( {e}_{2} {e}_{3} + {e}_{0} {e}_{1} ) sin λ \\ 2 ( {e}_{1} {e}_{3} + {e}_{0} {e}_{2} ) cos λ + ( {e}_{0}^{2} - {e}_{1}^{2} - {e}_{2}^{2} + {e}_{3}^{2} ) sin λ\end{matrix} ] + {δ}_{mt} ,$$

where δₘₜ denotes a noise induced by the magnetic sensing element 53.

In step 462, a set of acceleration difference is generated by comparing the target acceleration

$${[ \begin{matrix}{am}_{x , t} \\ {am}_{y , t} \\ {am}_{z , t}\end{matrix} ]}_{t}$$

with the current acceleration

$${[ \begin{matrix}{a}_{x , t} \\ {a}_{y , t} \\ {a}_{z , t}\end{matrix} ]}_{t} .$$

In step 463, a set of magnetic flux difference is generated by comparing the set of target magnetic flux

$${[ \begin{matrix}{mp}_{x , t} \\ {mp}_{y , t} \\ {mp}_{z , t}\end{matrix} ]}_{t}$$

and the set of current magnetic flux

$${[ \begin{matrix}{ma}_{x , t} \\ {ma}_{y , t} \\ {ma}_{z , t}\end{matrix} ]}_{t}$$

In step 464, when the disturbance parameter is not determined exceeding the disturbance threshold, the estimated attitude angle φₜ, the estimated attitude angle θₜ, and the estimated attitude angle ψₜ are updated according to the set of acceleration difference and the set of magnetic flux difference.

FIG. 8 is a schematic diagram showing the relationship between a carrier's local coordinate system and the world coordinate system. The estimated attitude angle φₜ, the estimated attitude angle θₜ, and the estimated attitude angle ψₜ belong to a local coordinate system of a carrier 80, which correspond to a position defined by an x-axis, a y-axis, and a z-axis of the carrier 80 itself. The carrier's local coordinate

$$[ \begin{matrix}x \\ y \\ z\end{matrix} ]$$

in the local coordinate system can be converted into a world coordinate

$$[ \begin{matrix}{x}^{′} \\ {y}^{′} \\ {z}^{′}\end{matrix} ]$$

in the world coordinate system in view of a direction cosine matrix. Their relationship can be described in terms of

$$[ \begin{matrix}{x}^{′} \\ {y}^{′} \\ {z}^{′}\end{matrix} ] = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] [ \begin{matrix}x \\ y \\ z\end{matrix} ] = [ \begin{matrix}{e}_{0}^{2} + {e}_{1}^{2} - {e}_{2}^{2} - {e}_{3}^{2} & 2 ( {e}_{1} {e}_{2} + {e}_{0} {e}_{3} ) & 2 ( {e}_{1} {e}_{3} - {e}_{0} {e}_{2} ) \\ 2 ( {e}_{1} {e}_{2} - {e}_{0} {e}_{3} ) & {e}_{0}^{2} - {e}_{1}^{2} + {e}_{2}^{2} - {e}_{3}^{2} & 2 ( {e}_{2} {e}_{3} + {e}_{0} {e}_{1} ) \\ 2 ( {e}_{1} {e}_{3} + {e}_{0} {e}_{2} ) & 2 ( {e}_{2} {e}_{3} - {e}_{0} {e}_{1} ) & {e}_{0}^{2} - {e}_{1}^{2} - {e}_{2}^{2} + {e}_{3}^{2}\end{matrix} ] [ \begin{matrix}x \\ y \\ z\end{matrix} ] ,$$

where R₁₁ to R₃₃ are parameters or elements of the direction cosine matrix.

While the disclosure has been described by way of example and in terms of the above embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for estimating three-dimensional (3D) attitude, the method comprising:
detecting a set of current angular velocity, a set of current magnetic flux, and a set of current acceleration of a carrier;
estimating a set of attitude angle according to the set of current angular velocity, a set of history attitude angle, and a motion model;
calculating a disturbance parameter according the set of current magnetic flux and a set of history magnetic flux;
determining whether the disturbance parameter exceeds a disturbance threshold;
updating, when the disturbance parameter is determined exceeding the disturbance threshold, the set of estimated attitude angle according to the set of current acceleration not the set of current magnetic flux; and
updating, when the disturbance parameter is determined not exceeding the disturbance threshold, the set of estimated attitude angle according to both the set of current acceleration and the set of current magnetic flux.

2. The method according to claim 1, further comprising:
expressing the set of history attitude angle as a history quaternion according to a direction sine matrix.

3. The method according to claim 2, wherein the step of estimating the set of attitude angle comprises:
estimating a set of quaternion according to the set of current angular velocity, the set of history quaternion, and the motion model; and
converting the set of estimated quaternion into a set of Euler attitude angle according to a direction cosine matrix, the set of Euler attitude angle being indicative of the estimated attitude angles.

4. The method according to claim 1, wherein the step of updating, when the disturbance parameter is determined exceeding the disturbance threshold, the set of estimated attitude angle according to the set of current acceleration comprises:
calculating a set of target acceleration and a set of target magnetic flux according to a measurement matrix;
generating a set of acceleration difference by comparing the set of target acceleration with the set of current acceleration;
generating a set of magnetic flux difference by comparing the set of target magnetic flux and the set of current magnetic flux; and
updating, when the disturbance parameter is determined exceeding the disturbance threshold, the set of estimated attitude angle according to the set of acceleration difference.

5. The method according to claim 1, wherein the step of updating, when the disturbance parameter is determined not exceeding the disturbance threshold, the set of estimated attitude angle according to the set of current acceleration comprises:
calculating a set of target acceleration and a set of target magnetic flux according to a measurement matrix;
generating a set of acceleration difference by comparing the set of target acceleration with the set of current acceleration;
generating a set of magnetic flux difference by comparing the set of target magnetic flux and the set of current magnetic flux; and
updating, when the disturbance parameter is determined not exceeding the disturbance threshold, the set of estimated attitude angle according to the set of acceleration difference and the set of magnetic flux difference.

6. The method according to claim 1, wherein the disturbance parameter is the absolute value of a change in magnetic flux, and the change in magnetic flux is a result of subtracting the norm of the set of current magnetic flux from the norm of the set of history magnetic flux.

7. The method according to claim 1, wherein the disturbance parameter is the absolute value of a change in magnetic inclination angle, and the change in magnetic inclination angle is a result of subtracting a current magnetic inclination angle from a history magnetic inclination angle.

8. The method according to claim 1, wherein the disturbance parameter is a combination change, and the combination change is a weighted sum of the absolute value of a change in magnetic flux and the absolute value of a change in magnetic inclination angle, wherein the change in magnetic flux is a result of subtracting the norm of the set of current magnetic flux from the norm of the set of history magnetic flux, and the change in magnetic inclination angle is a result of subtracting a current magnetic inclination angle from a history magnetic inclination angle.

9. The method according to claim 1, wherein the estimated attitude angle is updated by using a filter.

10. The method according to claim 9, wherein the filter is a Bayesian filter.

11. The method according to claim 9, wherein the filter is an extended Kalman filter (EKF).

12. The method according to claim 1, wherein the current angular velocity is detected by using an inertial sensing element.

13. The method according to claim 12, wherein the inertial sensing element is a gyroscope.

14. The method according to claim 1, wherein the current acceleration is detected by using an inertial sensing element.

15. The method according to claim 14, wherein the inertial sensing element is an accelerometer.

16. The method according to claim 1, wherein the current magnetic flux is obtained by using a magnetic sensing element.

17. The method according to claim 16, wherein the magnetic sensing element is an electronic compass, a magnetic resistance/impedance meter, a magneto-inductive wire device, or a Hall effect sensor.

18. The method according to claim 1, wherein the set of current angular velocity includes a three-axial angular velocity, the set of current magnetic flux includes a three-axial magnetic flux, and the set of current acceleration includes a three-axial acceleration.

19. An apparatus for estimating three-dimensional (3D) attitude, the apparatus comprising:
a first inertial sensing element configured to detect a set of current angular velocity of a carrier;
a second inertial sensing element configured to detect a set of current acceleration of the carrier;
a magnetic sensing element configured to detect a set of current magnetic flux of the carrier;
a processor configured to estimate a set of attitude angle according to the set of current angular velocity, a set of history attitude angle, and a motion model, the processor further configured to calculate a disturbance parameter according the set of current magnetic flux and a set of history magnetic flux, the processor further configured to determine whether the disturbance parameter exceeds a disturbance threshold, the processor further configured to update, when the disturbance parameter is determined exceeding the disturbance threshold, the set of estimated attitude angle according to the set of current acceleration not the set of current magnetic flux, the processor further configured to update, when the disturbance parameter is determined not exceeding the disturbance threshold, the set of estimated attitude angle according to both the set of current acceleration and the set of current magnetic flux.

20. The apparatus according to claim 19, wherein the processor converts the set of history attitude angle into a set of history quaternion according to a direction sine matrix.

21. The apparatus according to claim 20, wherein the processor estimates a set of quaternion according to the set of current angular velocity, the set of history quaternion, and the motion model, and the processor converts the set of estimated quaternion into the set of estimated attitude angle according to a direction cosine matrix.

22. The apparatus according to claim 20, wherein the processor calculates a set of target acceleration and a set of target magnetic flux according to a measurement matrix, the processor generates a set of acceleration difference by comparing the set of target acceleration with the set of current acceleration, the processor generates a set of magnetic flux difference by comparing the set of target magnetic flux and the set of current magnetic flux, and the processor updates, when the disturbance parameter is determined exceeding the disturbance threshold, the set of estimated attitude angle according to the set of acceleration difference.

23. The apparatus according to claim 20, wherein the processor calculates a set of target acceleration and a set of target magnetic flux according to a measurement matrix, the processor generates a set of acceleration difference by comparing the set of target acceleration with the set of current acceleration, the processor generates a set of magnetic flux difference by comparing the set of target magnetic flux and the set of current magnetic flux, and the processor updates, when the disturbance parameter is determined not exceeding the disturbance threshold, the set of estimated attitude angle according to the set of acceleration difference and the set of magnetic flux difference.

24. The apparatus according to claim 20, wherein the disturbance parameter is the absolute value of a change in magnetic flux, and the change in magnetic flux is a result of subtracting the norm of the set of current magnetic flux from the norm of the set of history magnetic flux.

25. The apparatus according to claim 20, wherein the disturbance parameter is the absolute value of a change in magnetic inclination angle, and the change in magnetic inclination angle is a result of subtracting a current magnetic inclination angle from a history magnetic inclination angle.

26. The apparatus according to claim 20, wherein the disturbance parameter is a combination change, and the combination change is a weighted sum of the absolute value of a change in magnetic flux and the absolute value of a change in magnetic inclination angle, wherein the change in magnetic flux is a result of subtracting the norm of the set of current magnetic flux from the norm of the set of history magnetic flux, and the change in magnetic inclination angle is a result of subtracting a current magnetic inclination angle from a history magnetic inclination angle.

27. The apparatus according to claim 20, wherein the processor executes an algorithm filter to update the estimated attitude angle.

28. The apparatus according to claim 27, wherein the filter is a Bayesian filter.

29. The apparatus according to claim 27, wherein the filter is an extended Kalman filter (EKF).

30. The apparatus according to claim 19, wherein the first inertial sensing element is a gyroscope.

31. The apparatus according to claim 19, wherein the second inertial sensing element is an accelerometer.

32. The apparatus according to claim 19, wherein the magnetic sensing element is an electronic compass, a magnetic resistance/impedance meter, a magneto-inductive wire device, or a Hall effect sensor.

33. The apparatus according to claim 19, wherein the set of current angular velocity includes a three-axial angular velocity, the set of current magnetic flux includes a three-axial magnetic flux, and the set of current acceleration includes a three-axial acceleration.
